(19) United States
(12) Patent Application Publication
(10) Pub. No.: US 2009/0239981 A1
(43) Pub. Date: Sep. 24, 2009

(54) WATER-BASED INKJET RECORDING INK

(75) Inventor: Kiyoshi MORIMOTO, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/402,884

(22) Filed: Mar. 12, 2009

(30) Foreign Application Priority Data
Mar. 19, 2008 (JP) 2008-071554

(51) Int. Cl. C09D 11/10

(52) U.S. Cl. 524/90

(57) ABSTRACT

A water-based inkjet recording ink including: a colored particle and an aqueous liquid medium, wherein the colored particle contains a quinacridone pigment; a synergist having a basic group; and a higher molecular vinyl polymer having at least one of a hydrophobic structural unit derived from phenoxyethyl acrylate or a hydrophobic structural unit derived from phenoxyethyl methacrylate and at least one of a hydrophilic structural unit derived from acrylic acid or a hydrophilic structural unit derived from methacrylic acid.

### CROSS-REFERENCE TO RELATED APPLICATION

This application claims priority under 35 USC 119 from Japanese Patent Application No. 2008-071554 filed on Mar. 19, 2008, the disclosure of which is incorporated by reference herein in its entirety.

### BACKGROUND OF THE INVENTION

1. Field of Invention

The present invention relates to a water-based inkjet recording ink.

2. Description of the Related Art

Various media have been used as a recording medium for inkjets, and high-quality images have been required for not only images on inkjet paper, but also for images on print media such as commercially available plain paper, quality paper, coated paper, or art paper. It is preferable to use a pigment as a colorant for ink, which imparts fastness such as waterproofness or light-fastness to plain paper or other print media. From the viewpoint of cost, the application of aqueous pigment-based inks has been widely examined. Among these, a quinacridone pigment has been preferably used as a pigment in magenta color ink for inkjet recording.

As a water-based inkjet recording ink, an aqueous dispersion for inkjet recording including a water-insoluble vinyl polymer particles dispersed therein has been disclosed (see, for example, Japanese Patent Application Laid-Open (JP-A) No. 2006-176623); the water-insoluble vinyl polymer particles contains a quinacridone pigment and a pigment derivative obtained by introducing an acidic group into an organic pigment, and the water-insoluble vinyl polymer has a structural unit derived from benzyl methacrylate and a structural unit having an anionic dissociable group. Specifically, a high printing density has been achieved by using dimethyl quinacridone pigment (P.R.122) as the quinacridone pigment, sulfonated dimethyl quinacridone as the pigment derivative, and a copolymer of benzyl methacrylate, polypropyleneglycol monomethacrylate, polyethylene glycol monomethacrylate, methacrylic acid, and styrene macromer as the water-insoluble vinyl polymer (a dispersant).

Further, for water paint and printing ink, a method for improving fluidity and storage stability by combining a quinacridone pigment, a basic pigment derivative, and a resin containing an acidic functional group is known (see, for example, JP-A No. 6-345997). Specifically, excellent fluidity, storage stability, glossiness, and waterproofness have been achieved by using unsubstituted quinacridone pigment (P. V.19) as the quinacridone pigment, N-dipropylamino propyl-sulfamoyl quinacridone as the pigment derivative, and a copolymer of styrene, ethyl acrylate, methyl methacrylate, and methacrylic acid as the resin.

Furthermore, as a technique to provide a stable pigment dispersion liquid having excellent fluidity suitable for ink for offset printing, ink for gravure printing, coating liquid ink, inkjet ink and the like, a combination of a quinacridone pigment, a basic pigment derivative, and a resin containing an acidic functional group has been disclosed (see, for example, Japan Patent No. 4029621). Specifically, a stable pigment dispersion has been achieved by using dimethyl quinacridone pigment (P.R.122) as the quinacridone pigment, quinacridone substituted by two N-methyl piperazinylmethyl acetamidomethyl groups as the pigment derivative, and a copolymer of methoxypolyethyleneglycol monomethacrylate, methyl methacrylate, n-butyl methacrylate, and 2-hydroxyethyl methacrylate as the resin.

### SUMMARY OF THE INVENTION

However, in the water-based inkjet recording ink formed using the aqueous pigment dispersion described in JP-A No. 2006-176623 or 6-345997, it is found that generation of unevenness in density and streaking is not sufficiently suppressed when the ink is used after being stored for a long period or after being exposed to high temperatures. Further, Japanese Patent No. 4029621 relates to an oil-base paint, and it is found that the dispersion stability of the dispersion obtained by the combination of the quinacridone pigment, pigment derivative, and copolymer is not sufficient for an aqueous dispersion.

Aspects of the invention include those described below.
<1> A water-based inkjet recording ink including a colored particle and an aqueous liquid medium, wherein the colored particle contains a quinacridone pigment; a synergist having a basic group; and a higher molecular vinyl polymer having (i) at least one of a hydrophobic structural unit derived from phenoxyethyl acrylate or a hydrophobic structural unit derived from phenoxyethyl methacrylate and (ii) at least one of a hydrophilic structural unit derived from acrylic acid or a hydrophilic structural unit derived from methacrylic acid.
<2> The water-based inkjet recording ink according to <1>, wherein the synergist is at least one selected from the group consisting of a quinacridone derivative, a triazine derivative, an acridone derivative, and an anthraquinone derivative.
<3> The water-based inkjet recording ink according to <1> or <2>, wherein the quinacridone pigment is at least one of C.I. Pigment Red 122 or C. I. Pigment Violet 19 and the synergist is a quinacridone derivative.
<4> The water-based inkjet recording ink according to <1> to <3>, wherein the content of the quinacridone pigment is from 2 mass % to 10 mass % with respect to the total mass of the water-based inkjet recording ink.
<5> The water-based inkjet recording ink according to <1> to <4>, wherein the basic group is at least one selected from the group consisting of a dialkylamino group, a morpholino group, a piperazinyl group, a pyrrolidinyl group, a piperidinyl group, a pyridyl group, and a triazinyl group.
<6> The water-based inkjet recording ink according to <1> to <5> wherein the content of the synergist having the basic group is from 0.5 parts by mass to 20 parts by mass based on 100 parts by mass of the pigment.
<7> The water-based inkjet recording ink according to <1> to <6>, wherein the content of the at least one of a hydrophobic structural unit derived from phenoxyethyl acrylate or a hydrophobic structural unit derived from phenoxyethyl methacrylate is from 20 mass % to 90 mass % and the content of the at least one of a hydrophilic structural unit derived from acrylic acid or a hydrophilic structural unit derived from methacrylic acid is from 5 mass % to 40 mass %, with respect to the total mass of the high-molecular-weight vinyl polymer.
<8> The water-based inkjet recording ink according to <1> to <7>, wherein the weight average molecular weight of the high-molecular-weight vinyl polymer is from 2,000 to 70,000.
<9> The water-based inkjet recording ink according to <1> to <8>, wherein the ratio of the addition amount of the high-molecular-weight vinyl polymer is from 10% to 100% with respect to the total mass of the pigment.
<10> The water-based inkjet recording ink according to <1 > to <9>, wherein the content of the colored particle is from 2 mass % to 10 mass % with respect to the total mass of the water-based inkjet recording ink.
<11> The water-based inkjet recording ink according to <1> to <10>, wherein the aqueous liquid medium including a water-soluble organic solvent.
<12> The water-based inkjet recording ink according to <11>, wherein the water-soluble organic solvent is a polyol compound.
<13> The water-based inkjet recording ink according to <11>, wherein the content of the water-soluble organic solvent is from 5 mass % to 60 mass % with respect to the total amount of the water-based inkjet recording ink.
<14> The water-based inkjet recording ink according to <1> to <13>, further comprising a surface tension adjusting agent.
<15> The water-based inkjet recording ink according to <1> to <14>, further comprising resin particles.

### DETAILED DESCRIPTION OF THE INVENTION

The inventor of the invention has found that a water-based inkjet recording ink having excellent jetting stability even after long term storage or after being exposed to high temperatures, and that can suppress generation of unevenness in density and streaking, can be obtained by modifying a surface of a quinacridone pigment with a synergist having a basic group and using a high-molecular-weight vinyl polymer having a specific structure to form a colored particle.

Inkjet Recording Ink

The inkjet recording ink of the invention (hereinafter, also referred to simply as “ink”) includes: at least one kind of colored particle containing a quinacridone pigment; a synergist having a basic group; a high-molecular-weight vinyl polymer having (i) at least one of a hydrophobic structural unit derived from phenoxyethyl acrylate or a hydrophobic structural unit derived from phenoxyethyl methacrylate and (ii) at least one of a hydrophilic structural unit derived from acrylic acid or a hydrophilic structural unit derived from methacrylic acid; and at least one aqueous liquid medium. The inkjet recording ink of the invention with the above composition can suppress generation of unevenness in density and streaking on various recording media during printing even after long term storage or after being exposed to high temperatures.

The inkjet recording ink of the invention may include a surfactant or other additional components, if needed.

Colored Particles

Quinacridone Pigment

The colored particle of the invention contains at least one kind of quinacridone pigment. The colored particle may contain other additional pigments, if needed.

The quinacridone pigment in the invention is not particularly limited as long as it is a pigment formed of a compound having a quinacridone skeleton. In the invention, the quinacridone pigment is preferably C. I. Pigment Red 122 or C. I. Pigment Violet 19 in consideration of hue. The quinacridone pigment in the invention may be used singly, or in combination of two or more kinds thereof.

In consideration of image density, the content of the quinacridone pigment in the invention is preferably from 2 mass % to 10 mass %, and more preferably 3 mass % to 7 mass %, with respect to the total mass of the water-based inkjet recording ink.

Synergist having a Basic Group

The colored particle of the invention contains at least one synergist having a basic group.

The synergist of the invention is a pigment derivative which has a partial structure similar to the chemical structure of the colorant forming the pigment and at least one type of hydrophilic group. In the invention, the at least one type of hydrophilic group includes at least one type of basic group.

The synergist in the invention can be adsorbed to the pigment by, for example, hydrophobic interactions and/or 7-7 interactions. The pigment surface can be converted to basic by the basic group of the synergist. When a high-molecular-weight vinyl polymer having an anionic group is used as a pigment dispersant, the affinity of the pigment for the pigment dispersant may be increased and the dispersion stability of the pigment may be improved more effectively.

The basic group of the invention is a group which is formed by removing at least one atom from a basic compound. Examples of the basic compound include a secondary or tertiary monoamine, a diamine, a saturated cyclic amine, an unsaturated cyclic amine, a carboxyl group-containing saturated cyclic amine, a carboxyl group-containing unsaturated cyclic amine, a hydroxyl group-containing saturated cyclic amine, a hydroxyl group-containing unsaturated cyclic amine, and a cyclic diamine.

Specific examples of the basic compound include dimethylamine, diethylamine, dibutylethylamine, dicyclohexylamine, N,N-dimethylamino ethylamine, N-methylpiperazine, 1-amino-4-methylpiperazine, 1-cyclopentyl piperazine, 2,6-lupetidine, 3-piperidinemethanol, pipecolic acid, isonipecotic acid, methyl isonipecotate, 2-piperidine ethanol, piperidine, 2-pipecoline, pyrrolidine, 3-hydroxy pyrrolidine, N-aminoethyl piperidine, N-aminoethyl morpholine, N-aminopropyl piperidine, and N-aminopropyl morpholine.

It is preferable that the basic group in the invention is at least one selected from a dialkylamino group, a morpholino group, a piperazinyl group, a pyrrolidinyl group, a piperidinyl group, a pyridyl group, or a triazinyl group in consideration of the dispersion stability of the colored particle over time. The synergist in the invention may include only one type of basic group, or two or more types of basic groups.

The partial structure similar to the chemical structure of the colorant forming the pigment in the invention is not particularly limited as long as the partial structure is similar to the compound that forms the pigment.

From the viewpoint of adsorptive property to the pigment, the synergist is preferably at least one selected from a quinacridone derivative, a triazine derivative, an acridone derivative, or an anthraquinone derivative. More preferably, the synergist is a quinacridone derivative.

The synergist in the invention has a partial structure similar to the chemical structure of the colorant forming the pigment and at least one type of basic group. In addition to the basic group, the synergist may have other additional substituent groups. Examples of other additional substituent groups include an alkyl group such as a methyl group, an ethyl group, a propyl group, or a butyl group; a hydroxyl group; an alkoxy group such as a methoxy group, an ethoxy group, or a butoxy group; a halogen atom such as a fluorine atom, a chlorine atom, or a bromine atom; and a phenyl group. The synergist in the invention may contain a single type of other additional substituent group, or a combination of two or more types of other substituent groups.

As the synergist having a basic group used in the invention, various synergists can be easily synthesized in accordance with synthesis methods described, for example, in JP-A Nos. 2003-43680 and 2007-131832. Specifically, the synergists each can be produced by a synthesis pathway in which a reactive substituent group (e.g., an acid halide, an alkyl halide) is introduced into a quinacridone, triazine, acridone, or anthraquinone derivative, and then the introduced reactive substituent group is reacted with a compound having a basic substituent group (e.g., N,N-dimethylamino ethylamine).

In the invention, in consideration of dispersion stability, the content of the synergist having a basic group is preferably from 0.5 parts by mass to 20 parts by mass, and more preferably from 1 part by mass to 10 parts by mass, based on 100 parts by mass of the pigment.

High-Molecular-Weight Vinyl Polymer

The high-molecular-weight vinyl polymer of the invention includes at least one of a hydrophobic structural unit derived from phenoxyethyl acrylate or a hydrophobic structural unit derived from phenoxyethyl methacrylate and at least one of a hydrophilic structural unit derived from acrylic acid or a hydrophilic structural unit derived from methacrylic acid. Due to the specific structure of the high-molecular-weight vinyl polymer, the dispersion stability of the ink can be improved, and generation of the unevenness in density and streaking can be suppressed even after long term storage or after being exposed to high temperatures. Here, “structural unit derived from . . . (A)” means a component in a polymer, which component is formed by the binding of (A) to an adjacent structural unit or units.

In the invention, the high-molecular-weight vinyl polymer serves as a dispersant and is contained in the water-based inkjet recording ink as a colored particle which includes the quinacridone pigment and the synergist having a basic group.

In addition to the at least one of a hydrophobic structural unit derived from phenoxyethyl acrylate or a hydrophobic structural unit derived from phenoxyethyl methacrylate and the at least one of a hydrophilic structural unit derived from acrylic acid or a hydrophilic structural unit derived from methacrylic acid, the high-molecular-weight vinyl polymer may contain additional structural units derived from compounds (hereinafter sometimes referred to as “other additional monomers”) which can be copolymerized with monomers constituting the component. Examples of the structural units derived from other additional monomers include a structural unit derived from a monomer having an α, β-ethylenic unsaturated group.

Specific examples of the monomer having an α, β-ethylenic unsaturated group include ethylene, propylene, butene, pentene, hexene, vinyl acetate, allyl acetate, crotonic acid, a crotonic acid ester, itaconic acid, an itaconic acid monoester, maleic acid, a maleic acid monoester, a maleic acid diester, fumaric acid, a fumaric acid monoester, vinyl sulfonic acid, styrene sulfonic acid, sulfonated vinyl naphthalene, vinyl alcohol, acrylamide, methacryloxy ethyl phosphate, bismethacryloxyethyl phosphate, methacryloxyethylphenyl acid phosphate, ethyleneglycol dimethacrylate, diethyleneglycol dimethacrylate, styrene, styrene derivatives such as α-methylstyrene or vinyltoluene; vinyl cyclohexane, vinyl naphthalene, vinyl naphthalene derivatives, an alkyl acrylate which may have an aromatic substituent, phenyl acrylate, an alkyl methacrylate which may have an aromatic substituent, phenyl methacrylate, a cycloalkyl methacrylate, an alkyl crotonate, a dialkyl itaconate, a dialkyl maleate, vinyl alcohol, and derivatives of the above compounds. Among these, an alkyl acrylate that may have an aromatic substituent, phenyl acrylate, and an alkyl methacrylate that may have an aromatic substituent, are preferable.

The high-molecular-weight vinyl polymer used in the invention can be produced by copolymerization of a monomer mixture containing (i) at least one of phenoxyethyl acrylate or phenoxyethyl methacrylate, (ii) at least one of acrylic acid or methacrylic acid, and, optionally, (iii) other additional monomers using a known polymerization method. For example, the high-molecular-weight vinyl polymer used in the invention can be produced by a solution polymerization method.

Solvents used in the solution polymerization method are not particularly limited, and a polar organic solvent is preferable. When the polar organic solvent is a water-miscible solvent, the polar organic solvent may be used as a mixture with water.

Examples of the polar organic solvent include methanol, ethanol, propanol, acetone, methyl ethyl ketone, and ethyl acetate.

For the copolymerization of the monomer mixture, a radical polymerization initiator can be used. Examples of the radical polymerization initiator include azo compounds such as 2,2′-azobisisobutyronitrile or 2,2′-azobis(2,4-dimethylvaleronitrile); and organic peroxides such as t-butylperoxy octoate, di-t-butyl peroxide, or dibenzoyloxide. In the invention, it is preferable to use an azo compound.

A polymerization chain transfer agent may be added during the copolymerization. Examples of the polymerization chain transfer agent include octyl mercaptan, n-dodecyl mercaptan, t-dodecyl mercaptan, n-tetradecyl mercaptan, mercaptoethanol, 3-mercapto-1,2-propanediol, mercaptosuccinic acid, and thiuram disulfides.

The polymerization temperature is preferably from 30° C. to 100° C., and more preferably from 50° C. to 80° C. The polymerization time is preferably from 1 hour to 20 hours. The polymerization atmosphere is preferably a nitrogen gas atmosphere or an inert gas atmosphere (e.g. argon).

After the polymerization reaction is complete, the water insoluble vinyl polymer thus formed can be isolated from the reaction solution by known methods such as a reprecipitation method or a solvent evaporation method. The water insoluble polymer thus obtained can be purified by removing the non-reacted monomer and the like using, for example, a reprecipitation method, a membrane separation method, or an extraction method.

The content of the at least one of a hydrophobic structural unit derived from phenoxyethyl acrylate or a hydrophobic structural unit derived from phenoxyethyl methacrylate in the high-molecular-weight vinyl polymer in the invention is preferably from 20 mass % to 90 mass %, and more preferably from 30 mass % to 90 mass %. The content of the at least one of a hydrophilic structural unit derived from acrylic acid or a hydrophilic structural unit derived from methacrylic acid in the high-molecular-weight vinyl polymer in the invention is preferably from 5 mass % to 40 mass %, and more preferably 5 mass % to 30 mass %.

The weight average molecular weight of the high-molecular-weight vinyl polymer in the invention is preferably from 2,000 to 70,000, and more preferably from 20,000 to 60,000.

The weight average molecular weight is determined by measuring the average molecular weight by gel permeation chromatography (using tetrahydrofuran as a carrier) and converting the measured value using polystyrene as a reference material.

For the high-molecular-weight vinyl polymer in the invention, it is preferable that the content of the at least one of a hydrophobic structural unit derived from phenoxyethyl acrylate or a hydrophobic structural unit derived from phenoxyethyl methacrylate is from 20 mass % to 90 mass %, the content of the at least one of a hydrophilic structural unit derived from acrylic acid or a hydrophilic structural unit derived from methacrylic acid is from 5 mass % to 40 mass %, and the weight average molecular weight is from 2,000 to 70,000. It is more preferable that the content of the at least one of a hydrophobic structural unit derived from phenoxyethyl acrylate or a hydrophobic structural unit derived from phenoxyethyl methacrylate is from 30 mass % to 90 mass %, the content of the at least one of a hydrophilic structural unit derived from acrylic acid or a hydrophilic structural unit derived from methacrylic acid is from 5 mass % to 30 mass %, and the weight average molecular weight is from 20,000 to 60,000.

The high-molecular-weight vinyl polymer is contained in the water-based inkjet recording ink of the invention and forms a colored particle together with at least one quinacridone pigment and at least one synergist having a basic group.

The method for producing the colored particle in the invention is not particularly limited. For example, the method for producing an encapsulated pigment described in JP-A No. 10-140065 may be used. Specifically, the high-molecular-weight vinyl polymer, quinacridone pigment, and synergist having a basic group are dispersed in an aqueous medium containing an organic solvent, then at least a part of the organic solvent is removed, whereby an aqueous dispersion of the colored particles can be obtained.

From the viewpoint of dispersion stability, the ratio of the addition amount of the high-molecular-weight vinyl polymer in the invention is preferably from 10% to 100%, and more preferably from 30% to 60% , with respect to the total mass of the pigment.

The content of the colored particle in the water-based inkjet recording ink is preferably from 2 mass % to 10 mass %, and more preferably 3 mass % to 7 mass %, in consideration of image density.

Aqueous Liquid Medium

The water-based inkjet recording ink in the invention contains an aqueous liquid medium. The aqueous liquid medium includes water and at least one type of water-soluble organic solvent. The water-soluble organic solvent may be used as an anti-drying agent, a wetting agent or a penetration accelerator. Specifically, the anti-drying agent is used for the purpose of preventing clogging of an inkjet nozzle due to drying of the inkjet ink. As the anti-drying agent or wetting agent, a water-soluble organic solvent with a lower vapor pressure than that of water is preferable. In view of facilitating infiltration of inkjet ink into paper, a water-soluble organic solvent is preferably used as the penetration accelerator.

Here, the “water-soluble organic solvent” in the invention means an organic solvent of which 5 g or more can dissolve in 100 g of water.

Examples of the water-soluble organic solvent include polyhydric alcohols including glycerin, 1,2,6-hexanetriol, trimethylolpropane, and alkanediols such as ethyleneglycol, propyleneglycol, diethyleneglycol, triethyleneglycol, tetraethyleneglycol, pentaethyleneglycol, dipropyleneglycol, 2-butene-1,4-diol, 2-ethyl-1,3-hexanediol, 2-methyl-2,4-pentanediol, 1,2-octanediol, 1,2-hexanediol, 1,2-pentanediol, or 4-methyl-1,2-pentanediol; so-called solid wetting agents including saccharides such as glucose, mannose, fructose, ribose, xylose, arabinose, galactose, aldonic acid, glucitol, maltose, cellobiose, lactose, sucrose, trehalose or maltotriose; sugar alcohols; hyaluronic acids; and ureas; alkyl alcohols having 1 to 4 carbon atoms such as ethanol, methanol, butanol, propanol or isopropanol; glycol ethers such as ethyleneglycol monomethyl ether, ethyleneglycol monoethyl ether, ethyleneglycol monobutyl ether, ethyleneglycol monomethyl ether acetate, diethyleneglycol monomethyl ether, diethyleneglycol monoethyl ether, diethyleneglycol mono-n-propyl ether, ethyleneglycol mono-iso-propyl ether, diethyleneglycol mono-iso-propyl ether, ethyleneglycol mono-n-butyl ether, ethyleneglycol mono-t-butyl ether, diethyleneglycol mono-t-butyl ether, propyleneglycol monomethyl ether, propyleneglycol monoethyl ether, propyleneglycol mono-t-butyl ether, propyleneglycol mono-n-propyl ether, propyleneglycol mono-iso-propyl ether, dipropyleneglycol monomethyl ether, dipropyleneglycol monoethyl ether, dipropyleneglycol mono-n-propyl ether or dipropyleneglycol mono-iso-propyl ether; 2-pyrrolidone, N-methyl 2-pyrrolidone, 1,3-dimethyl-2-imidazolidinone, formamide, acetamide, dimethylsulfoxide, sorbit, sorbitan, acetin, diacetin, triacetin, and sulfolane. The water-soluble organic solvent may be used singly, or in combination of two or more thereof.

When the water-soluble organic solvent is used for the purpose of an anti-drying agent or a wetting agent, the water-soluble organic solvent is preferably a polyhydric alcohol, and examples thereof include glycerin, ethyleneglycol, diethyleneglycol, triethyleneglycol, propyleneglycol, dipropyleneglycol, tripropyleneglycol, 1,3-butanediol, 2,3-butanediol, 1,4-butanediol, 3-methyl-1,3-butanediol, 1,5-pentanediol, tetraethyleneglycol, 1,6-hexanediol, 2-methyl-2,4-pentanediol, polyethyleneglycol, 1,2,4-butanetriol, and 1,2,6-hexanetriol. The water-soluble organic solvent as an anti-drying agent or a wetting agent may be used singly, or in combination of two or more thereof.

When the water-soluble organic solvent is used for the purpose of a penetrating agent, the water-soluble organic solvent is preferably a polyol compound. Examples of the polyol compound include aliphatic diols such as 2-ethyl-2-methyl-1,3-propanediol, 3,3-dimethyl-1,2-butanediol, 2,2-diethyl-1,3-propanediol, 2-methyl-2-propyl-1,3-propanediol, 2,4-dimethyl-2,4-pentanediol, 2,5-dimethyl-2,5-hexanediol, 5-hexene-1,2-diol, 2-ethyl-1,3-hexanediol, or 2,2,4-trimethyl-1,3-pentanediol. Among these compounds, 2-ethyl-1,3-hexanediol and 2,2,4-trimethyl-1,3-pentanediol are preferable.

The water-soluble solvent used in the invention may be used singly, or two or more kinds thereof may be mixed and used.

The content of the water-soluble solvent in the water-based inkjet recording ink of the invention is preferably from 5 mass % to 60 mass %, and more preferably from 10 mass % to 40 mass %, with respect to the total amount of the water-based inkjet recording ink.

Although the addition amount of water used for the water-based inkjet recording ink of the invention is not particularly limited, the addition amount of water is preferably from 10 mass % to 99 mass %, more preferably from 30 mass % to 80 mass %, and even more preferably from 50 mass % to 70 mass %, with respect to the total amount of the water-based inkjet recording ink.

Surfactant

The ink of the invention may contain a surface tension adjusting agent. Examples of the surface tension adjusting agent include a nonionic surfactant, a cationic surfactant, an anionic surfactant and a betaine surfactant. In order for the ink of the invention to be applied by inkjet system, the addition amount of the surface tension adjusting agent is such an amount that the surface tension of the ink of the invention at 25° C. s adjusted preferably to a range of from 20 mN/m to 60 mN/m, more preferably from 20 mN/m to 45 mN/m, and still more preferably from 25 mN/m to 40 mN/m.

As the surfactant of the invention, a compound having a structure in which a hydrophilic moiety and a hydrophobic moiety are included in a molecule can be effectively used. Any of an anionic surfactant, a cationic surfactant, an amphoteric (betainic) surfactant, and a nonionic surfactant can be used. Furthermore, the above-mentioned high-molecular-weight vinyl polymer (polymer dispersant) can be used as a surfactant.

Examples of the anionic surfactant include sodium dodecylbenzene sulfonate, sodium lauryl sulfate, a sodium alkyl diphenylether disulfonate, a sodium alkylnaphthalene sulfonate, a sodium dialkyl sulfosuccinate, sodium stearate, potassium oleate, sodium dioctylsulfosuccinate, a sodium polyoxyethylene alkylether sulfate, a sodium polyoxyethylene alkylphenylether sulfate, sodium dialkylsulfosuccinate, sodium stearate, sodium oleate, and sodium t-octylphenoxyethoxy-polyethoxyethyl sulfate. The anionic surfactant may be used singly, or in combination of two or more thereof.

Examples of the nonionic surfactant include polyoxyethylene lauryl ether, polyoxyethylene octyl phenyl ether, polyoxyethylene oleyl phenyl ether, polyoxyethylene nonyl phenyl ether, an oxyethylene-oxypropylene block copolymer, t-octyl phenoxyethyl polyethoxyethanol, and nonylphenoxyethyl polyethoxyethanol. The nonionic surfactant may be used singly, or in combination of two or more thereof.

Examples of cationic surfactant include a tetraalkyl ammonium salt, an alkylamine salt, a benzalkonium salt, an alkylpyridinium salt, and an imidazolium salt. Specific examples include dihydroxyethyl stearylamine, 2-heptadecenyl-hydroxyethyl imidazoline, lauryldimethyl benzyl ammonium chloride, cetyl pyridinium chloride, and stearamide methylpyridium chloride.

The addition amount of the surfactants to be added to the inkjet recording ink of the invention is not specifically limited, but is preferably from 1 mass % or more, more preferably from 1 mass % to 10 mass %, and even more preferably from 1 mass % to 3 mass %.

Other Components

The inkjet recording ink of the invention may contain other additives. Examples of other additives include known additives such as an ultraviolet absorber, an anti-fading agent, an antifungal agent, a pH adjuster, an antirust agent, an antioxidant, an emulsion stabilizer, an antiseptic agent, a defoaming agent, a viscosity adjustment agent, a dispersion stabilizer or a chelating agent.

Examples of the ultraviolet absorber include a benzophenone ultraviolet absorber, a benzotriazole ultraviolet absorber, a salicylate ultraviolet absorber, a cyanoacrylate ultraviolet absorber, and a nickel complex salt ultraviolet absorber.

As anti-fading agents, various organic and metal complex anti-fading agents can be used. Organic anti-fading agents include hydroquinones, alkoxyphenols, dialkoxyphenols, phenols, anilines, amines, indans, chromanes, alkoxy anilines, and heterocycles. Examples of the metal complexes include a nickel complex and a zinc complex.

Examples of the antifungal agent include sodium dehydroacetate, sodium benzoate, sodium pyridinethione-1-oxide, ethyl p-hydroxybenzoate, 1,2-benzisothiazoline-3-one, sodium sorbate, and sodium pentachlorophenol. The content of antifungal agent in the ink composition is preferably from 0.02 mass % to 1.00 mass %.

The pH adjuster is not specifically limited as long as the pH adjuster can adjust a pH value to a desired value without exerting an adverse influence on a recording ink to which the pH adjuster is added. The pH adjuster may be selected appropriately in accordance with the purpose. Examples of the pH adjuster include alcohol amines such as diethanlol amine, triethanol amine, or 2-amino-2-ethyl-1,3-propanediol; alkali metal hydroxides such as lithium hydroxide, sodium hydroxide, or potassium hydroxide; ammonium hydroxides such as ammonium hydroxide or quaternary ammonium hydroxide; phosphonium hydroxide; and alkali metal carbonates.

Examples of the antirust agent include acid sulfite, sodium thiosulfate, ammonium thiodiglycolate, diisopropyl ammonium nitrite, pentaerythritol tetranitrate, and dicyclohexyl ammonium nitrite.

Examples of the antioxidant include phenolic antioxidants (including hindered phenol antioxidants), amine antioxidants, sulfur antioxidants, and phosphorus antioxidants.

Examples of the chelating agent include sodium ethylenediamine tetraacetate, sodium nitrilotriacetate, sodium hydroxyethyl ethylenediamine triacetate, sodium diethylenetriamine pentaacetate, and sodium uramil diacetate.

Resin Particles

The water-based inkjet recording ink of the invention may contain resin particles or polymer latexes. Examples of the resin particles or polymer latexes include an acrylic resin, a vinyl acetate resin, a styrene-butadiene resin, a vinyl chloride resin, an acryl-styrene resin, a butadiene resin, a styrene resin, a crosslinked acrylic resin, a crosslinked styrene resin, a benzoguanamine resin, a phenol resin, a silicone resin, an epoxy resin, a urethane resin, a paraffin resin and a fluororesin Among these resins, an acrylic resin, an acryl-styrene resin, a styrene resin, a crosslinked acrylic resin, and a crosslinked styrene resin are preferable.

The weight average molecular weight of the resin particles is preferably from 10,000 to 200,000, and more preferably from 100,000 to 200,000.

The average particle diameter of the resin particles is preferably from 10 nm to 1 μm, more preferably from 10 nm to 200 nm, even more preferably from 20 nm to 100 nm and particularly preferably from 20 nm to 50 nm.

The addition amount of the resin particles is preferably from 0.5 mass % to 20 mass %, more preferably from 3 mass % to 20 mass %, and even more preferably from 5 mass % to 15 mass %.

The glass transition temperature Tg of the resin particles is preferably 30° C. or more, more preferably 40° C. or more, and even more preferably 50° C. or more.

The particle size distribution of the polymer particles is not specifically restricted. Therefore, polymer particles with a broad particle size distribution and polymer particles with a monodispersed particle size distribution are both usable. Moreover, two or more kinds of polymer particles each having a monodispersed particle size distributions may be mixed and used as a mixture.

Printability-Improving Liquid Composition

Preferable examples of the inkjet recording method using the water-based inkjet recording ink of the invention include an inkjet recording method including a process of applying a printability-improving liquid composition onto a recording medium.

Preferable examples of the printability-improving liquid composition include a liquid composition that, when mixed with a water-based inkjet recoding ink, causes aggregation by changing the pH of the water-based inkjet recoding ink. The pH of the liquid composition is preferably from 1 to 6, more preferably from 2 to 5, and still more preferably from 3 to 5.

The printability-improving liquid composition may include a component that causes aggregation of the pigment, and the examples of the component includes a polyvalent metal salt, an organic acid, a polyallylamine, and derivatives thereof.

Examples of the polyvalent metal salt include a metal salt of any of the following: a salt of an alkaline earth metal belonging to Group 2 of the Periodic Table (for example, magnesium or calcium), a salt of a transition metal belonging to Group 3 of the Periodic Table (for example, lanthanum), a salt of a cation derived from an element belonging to Group 13 of the Periodic Table (for example aluminum), or a salt of a lanthanide (for example neodymium). Preferable examples of the metal salt include a carboxylate (for example, a formate, an acetate, or a benzoate), a nitrate, a chloride, or a thiocyanate. Among them, more preferable examples include a calcium or magnesium salt of a carboxylic acid (such as formic acid, acetic acid, or benzoic acid), a calcium or magnesium salt of nitric acid, calcium chloride, magnesium chloride, and a calcium or magnesium salt of thiocyanic acid.

The organic acid is preferably selected, for example, from the following: polyacrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidonecarboxylic acid, pyronecarboxylic acid, pyrrolecarboxylic acid, furancarboxylic acid, pyridinecarboxylic acid, coumalic acid, thiophenecarboxylic acid, nicotinic acid, derivatives thereof, and salts thereof.

The component that causes aggregation of the pigment may be used singly or in combination of two or more thereof.

The content of the component that causes aggregation in the printability-improving liquid is preferably from 1 mass % to 10 mass %, more preferably from 1.5 mass % to 7 mass %, and still more preferably from 2 mass % to 6 mass %.

Physical Properties of Inkjet Recording Liquid

The surface tension of the inkjet recording ink of the invention is preferably from 20 mN/m to 60 mN/m, more preferably from 20 mN/m to 45 mN/m, and still more preferably from 25 mN/m to 40 mN/m.

The viscosity of the inkjet recording ink of the invention at 20° C. is preferably from 1.2 mPa·s to 15.0 mPa·s, more preferably from 2 mPa·s to less than 13 mPa·s, and still more preferably from 2.5 mPa·s to less than 10 mPa·s.

Inkjet Recording Method

In a preferable inkjet recording method using the inkjet recording ink of the invention, energy is supplied to an inkjet recording ink to form an image on a known image receiving material such as plain paper, resin coated paper, inkjet paper as those described in JP-A Nos. 8-169172, 8-27693, 2-276670, 7-276789, 9-323475, 62-238783, 10-153989, 10-217473, 10-235995, 10-337947, and 10-217597, a film, electrophotographic common paper, fabrics, glass, metal or ceramics. In addition, as an inkjet recording method applied to the invention, the inkjet recording method described in the paragraphs [0093] to [0105] of JP-A No. 2003-306623 is preferable.

When forming an image, a polymer latex compound (resin particle) may be used together for the purpose of imparting glossiness and water resistance or of improving weather-resistance. The time when the latex compound is added to the image receiving material may be before, after, or simultaneously with application of a colorant. Accordingly, the latex compound may be added to an image receiving paper or added to an ink, or may be used as an independent liquid of the polymer latex. More specifically, methods described in JP-A Nos. 2002-166638, 2002-121440, 2002-154201, 2002-144696 and 2002-080759 can be preferably used.

A preferable example of an image forming method is an inkjet recording method including the following processes:

a first process, being a process of applying a printability-improving liquid composition onto a recording medium;

a second process, being a process of applying an water-based inkjet recording ink onto the recording medium onto which the liquid composition has been applied; and

other additional processes, which are not particularly limited, and may be suitably selected according to the purpose.

Examples of the additional processes include a drying and removal process, and a heating and fixing process. The drying and removal process is not specifically restricted as long as the ink solvent in the water-based inkjet recording ink that is applied to a recording medium can be dried and removed by the process, and the process may be suitably selected according to the purpose. The heating and fixing process is not specifically restricted as long as resin particles or polymer latexes contained in the water-based inkjet recording ink used in the inkjet recording method are fused and fixed in the process, and the process may be suitably selected according to the purpose.

Another example of a preferable image forming system in the invention includes:

a first process, being a process of applying a printability-improving liquid composition onto an intermediate transfer medium;

a second process, being a process of applying an water-based inkjet recording ink onto the intermediate transfer medium onto which the liquid composition has been provided;

a third process, being a process of transferring an ink image formed on the intermediate transfer medium onto a recording medium; and

other additional processes, which are not particularly limited, and may be suitably selected according to the purpose. Examples of the additional processes include a drying and removal process, and a heating and fixing process.

### EXAMPLES

Hereinafter, the invention will be described in more detail with reference to examples, but the invention is not limited to the examples. Further, “parts” and “%” indicate quantities in terms of mass, unless otherwise specified.

Synthesis Example of Synergist S1 having a Basic Group

2,9-dimethyl quinacridone was chloroacetamidemethylated in the ordinary manner, and then reacted with dimethylaminopropylamine, whereby dimethylaminopropylamino acetamidomethyl-2,9-dimethyl quinacridone was synthesized.

Synthesis Example of Synergist S2 having a Basic Group

2-methoxy-4-phenylamino-6-amino-1,3,5-triazine was reacted with N-chloroethylmorpholine, whereby 2-methoxy-4-phenylamino-6-morpholinoethylamino-1,3,5-triazine was synthesized.

Synthesis Example of Synergist S3 having a Basic Group

Acridone was chlorosulfonated in the ordinary manner and then reacted with morpholino propylamine, whereby 2-morpholinopropyl sulfamoyl acridone was synthesized.

Synthesis Example of Synergist S4 having a Basic Group

Anthraquinone-2-carboxylic acid was converted into acid chloride in the ordinary manner, and then reacted with dimethylaminopropylamine, whereby 2-N-dimethylaminopropyl carbamoyl-anthraquinone was synthesized.

The structures of synergists S1 to S4 having a basic group synthesized above are shown below.

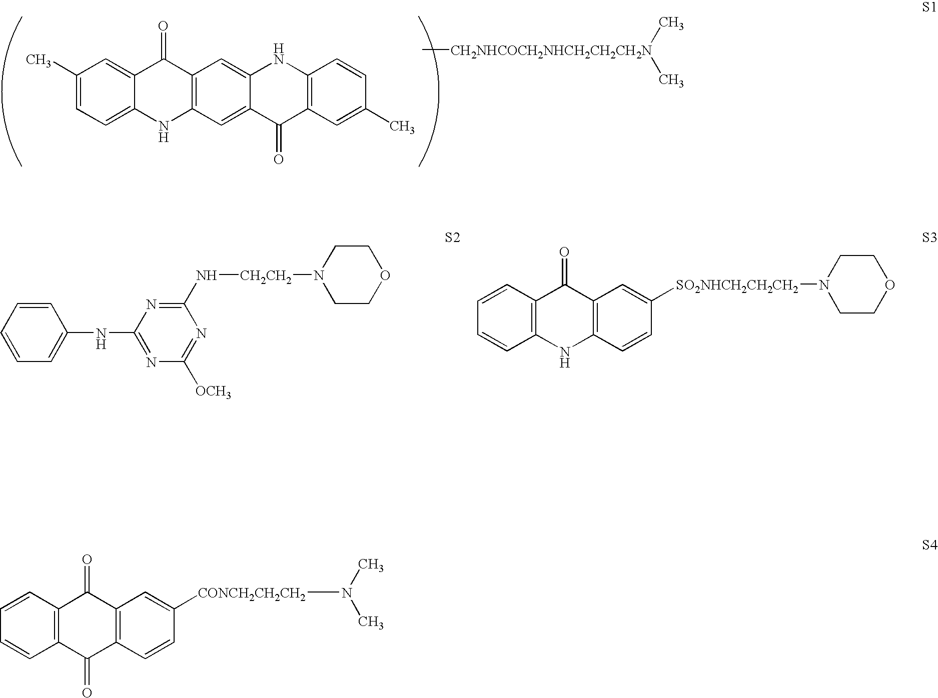

Example of Preparation of High-Molecular-Weight Vinyl Polymer

The following components were mixed to give a total amount of the monomer components of 100 parts by mass. Then, as a polymerization initiator, 1 part by mass of 2,2′-azobis(2,4-dimethylvaleronitrile) was added thereto, and nitrogen gas replacement was sufficiently carried out, whereby a synthetic mixture was obtained.

Composition of High-Molecular-Weight Vinyl Polymer

Phenoxyethyl methacrylate 85 parts by mass

Methacrylic acid 15 parts by mass

2-mercaptoethanol 0.1 parts by mass

Subsequently, 100 parts by mass of methyl ethyl ketone were heated, while stirred, to 75° C. under a nitrogen atmosphere. The synthetic mixture obtained above was added dropwise to the methyl ethyl ketone over 4 hours at 75° C. while stirring, and the reaction was continued for another 6 hours at 75° C. while stirring. Then, the reaction mixture was naturally cooled to 25° C. Thereafter, the reaction mixture was diluted with methyl ethyl ketone to give a solid content of 50%, whereby a solution of a high-molecular-weight vinyl polymer with a weight average molecular weight of 41,000 was obtained.

### Example 1

Respective high-molecular-weight vinyl polymers having a solid content of 50% were prepared in the same manner as in the example of preparation of the high-molecular-weight vinyl polymer, except that the monomer composition of the high-molecular-weight vinyl polymer was changed as shown in Table 1.

10 parts by mass of obtained high-molecular-weight vinyl polymer solution having a solid content of 50% was neutralized with an aqueous solution of NaOH (5 mol/L). The alkali was added in an amount such that methacrylic acid or acrylic acid in the high-molecular-weight vinyl polymer was completely neutralized.

Subsequently, 10 parts by mass of C.I. Pigment Red 122 (trade name: CROMOPHTAL Jet Magenta DMQ, manufactured by Ciba Specialty Chemicals Inc.) and 1 part by mass of a synergist having a basic group (synergist S1) were added to the high-molecular-weight vinyl polymer solution, the mixture was then kneaded with a roll mill for 2 to 8 hours depending on the requirement, and the kneaded product was dispersed in 100 parts by mass of ion exchanged water. The organic solvent was completely removed from the resulting dispersed product at 60° C. under reduced pressure, and a part of the water was removed to concentrate the dispersed product, whereby an aqueous dispersion of a colored particle (a high-molecular-weight vinyl polymer particle containing a pigment) with a solid content of 20% by mass was obtained (Experiments 101 to 114).

Other experiments were performed without using a synergist having a basic group (Experiments 115 to 118). Table 1 also shows whether or not the synergist was added.

The aqueous dispersion of the colored particle obtained above was mixed with the following components to prepare an inkjet recording ink.

Ink component

| | | |
|---|---|---|
| Aqueous dispersion of the colored particle | 30 | parts by mass |
| Glycerol | 15 | parts by mass |
| Diethyleneglycol | 10 | parts by mass |
| Diethyleneglycol monoethylether | 5 | parts by mass |
| Triethanolamine | 1 | part by mass |
| OLFINE E1010 (trade name, manufactured by | 1 | part by mass |
| Nisshin Chemical Industry Co., Ltd.) | | |
| Ion exchanged water | 38 | parts by mass |

The pH of the obtained inkjet recording ink was measured using a pH meter (trade name: WM-50EG, manufactured by DKK-TOA CORPORATION). The pH of the inkjet recording ink was found to be 8.5.

Evaluation of Jetting Accuracy

Each of the obtained inkjet recording ink was placed into respective containers made of PET, which were sealed and left at 60° C. for 2 weeks. Subsequently, a 10-cm line was printed using an inkjet recording apparatus (trade name: DMP-2831 printer, manufactured by FUJIFILM Dimatix Inc.) under given conditions (ink droplet amount: 2 pL, discharge frequency: 20 kHz, nozzle arrangement direction×transport direction: 16×1200 dpi). As a recording medium, color photofinishing paper (trade name: Kassai Photofinish PRO, manufactured by FUJIFILM Corporation) was used.

The distance between lines at a distance of 5 cm from the ink jetting start position of the printed sample was measured using a dot analyzer (trade name: DA-6000, manufactured by Oji Scientific Instruments). Then, the standard deviation was calculated and accuracy in the jetting direction was evaluated as follows.

### Evaluation Criteria

A: The standard deviation of the distance between lines was less than 3 μm.
B: The standard deviation of the distance between lines was 3 μm or more and less than 4 μm.
C: The standard deviation of the distance between lines was 4 μm or more and less than 5 μm.
D: The standard deviation of the distance between lines was 5 μm or more.

TABLE 1

| | | | | | | | Addition | | |
|---|---|---|---|---|---|---|---|---|---|
| | | | | | | | ratio | | |
| | | | | | | | of the high- | | |
| | | Compositional ratio of high-molecular-weight | | | | Weight | molecular- | | |
| | | vinyl polymer (parts) | | | | average | weight vinyl | | |
| | | Phenoxyethyl | Methacrylic | Methyl | Benzyl | molecular | polymer to | Jetting | |
| Experiment | Synergist | methacrylate | acid | methacrylate | methacrylate | weight | the pigment | accuracy | Remarks |
| 101 | S1 | 10 | 45 | 45 | 0 | 42000 | 50% | B | Invention |
| 102 | S1 | 20 | 40 | 40 | 0 | 47000 | 50% | B | Invention |
| 103 | S1 | 30 | 30 | 40 | 0 | 44000 | 50% | A | Invention |
| 104 | S1 | 50 | 20 | 30 | 0 | 46000 | 50% | A | Invention |
| 105 | S1 | 80 | 20 | 0 | 0 | 41000 | 50% | A | Invention |
| 106 | S1 | 90 | 10 | 0 | 0 | 48000 | 50% | A | Invention |
| 107 | S1 | 90 | 5 | 5 | 0 | 49000 | 50% | A | Invention |
| 108 | S1 | 0 | 45 | 45 | 10 | 48000 | 50% | D | Comparative |
| | | | | | | | | | Example |
| 109 | S1 | 0 | 40 | 40 | 20 | 45000 | 50% | D | Comparative |
| | | | | | | | | | Example |
| 110 | S1 | 0 | 30 | 40 | 30 | 41000 | 50% | D | Comparative |
| | | | | | | | | | Example |
| 111 | S1 | 0 | 20 | 30 | 50 | 49000 | 50% | C | Comparative |
| | | | | | | | | | Example |
| 112 | S1 | 0 | 20 | 0 | 80 | 44000 | 50% | C | Comparative |
| | | | | | | | | | Example |
| 113 | S1 | 0 | 10 | 0 | 90 | 42000 | 50% | C | Comparative |
| | | | | | | | | | Example |
| 114 | S1 | 0 | 5 | 5 | 90 | 45000 | 50% | C | Comparative |
| | | | | | | | | | Example |
| 115 | None | 50 | 20 | 30 | 0 | 46000 | 50% | C | Comparative |
| | | | | | | | | | Example |
| 116 | None | 80 | 20 | 0 | 0 | 41000 | 50% | C | Comparative |
| | | | | | | | | | Example |
| 117 | None | 0 | 20 | 30 | 50 | 49000 | 50% | D | Comparative |
| | | | | | | | | | Example |
| 118 | None | 0 | 20 | 0 | 80 | 44000 | 50% | D | Comparative |
| | | | | | | | | | Example |

From Experiments 101 to 107, it was found that by using Pigment Red 122 as the pigment together with synergist S1 having a basic group and the high-molecular-weight vinyl polymer according to the invention, a sufficient ink jetting accuracy was obtained even after storage under high temperatures. In other words, it was found that generation of the unevenness in density and streaking due to a reduction in ink jetting accuracy could be suppressed.

Furthermore, from Experiments 108 to 114, it was found that the jetting accuracy deteriorated when benzyl methacrylate was used as a constituent monomer of the high-molecular-weight vinyl polymer in place of phenoxyethyl methacrylate.

In addition from the results of Experiments 115 to 118, it was found that the jetting accuracy deteriorated when the synergist having a basic group of the invention was not used.

### Example 2

Each of the inkjet recording inks was prepared in the same manner as in Example 1, except that the monomer composition of the high-molecular-weight vinyl polymer and the synergist in Example 1 were changed as shown in Table 2 (Experiments 201 to 208). The discharge accuracy was evaluated in the same manner as in Example 1.

TABLE 2

| | | | | | | | Addition | | |
|---|---|---|---|---|---|---|---|---|---|
| | | | | | | | ratio | | |
| | | | | | | | of the high- | | |
| | | Compositional ratio of high-molecular-weight | | | | Weight | molecular- | | |
| | | vinyl polymer (parts) | | | | average | weight vinyl | | |
| | | Phenoxyethyl | Methacrylic | Methyl | Benzyl | molecular | polymer to | Jetting | |
| Experiment | Synergist | methacrylate | acid | methacrylate | methacrylate | weight | the pigment | accuracy | Remarks |
| 201 | S1 | 80 | 20 | 0 | 0 | 41000 | 50% | A | Invention |
| 202 | S2 | 80 | 20 | 0 | 0 | 41000 | 50% | B | Invention |
| 203 | S3 | 80 | 20 | 0 | 0 | 41000 | 50% | A | Invention |
| 204 | S4 | 80 | 20 | 0 | 0 | 41000 | 50% | B | Invention |
| 205 | S1 | 0 | 20 | 0 | 80 | 44000 | 50% | C | Comparative |
| | | | | | | | | | Example |
| 206 | S2 | 0 | 20 | 0 | 80 | 44000 | 50% | C | Comparative |
| | | | | | | | | | Example |
| 207 | S3 | 0 | 20 | 0 | 80 | 44000 | 50% | D | Comparative |
| | | | | | | | | | Example |
| 208 | S4 | 0 | 20 | 0 | 80 | 44000 | 50% | D | Comparative |
| | | | | | | | | | Example |

From Experiments 201 to 204, it was found that a sufficient ink jetting accuracy could be obtained by using synergists S1 to S4 having the basic group according to the invention and the high-molecular-weight vinyl polymer according to the invention.

From Experiments 205 to 208, it was found that the jetting accuracy deteriorated when benzyl methacrylate was used as a constituent monomer of the high-molecular-weight vinyl polymer in place of phenoxyethyl methacrylate.

### Example 3

Each of the inkjet recording inks was prepared in the same manner as in Example 1, except that the monomer composition of the high-molecular-weight vinyl polymer, the weight average molecular weight of the high-molecular-weight vinyl polymer, and the addition ratio of the high-molecular-weight vinyl polymer in Example 1 were changed as shown in Table 3 (Experiments 301 to 312). The jetting accuracy was evaluated in the same manner as in Example 1.

Here, the high-molecular-weight vinyl polymers having the weight average molecular weights shown in Table 3 were obtained by suitably changing the polymerization conditions of the high-molecular-weight vinyl polymer according to an ordinary method.

TABLE 3

| | | | | | | | Addition ratio | | |
|---|---|---|---|---|---|---|---|---|---|
| | | | | | | | of the high- | | |
| | | Compositional ratio of high-molecular-weight | | | | Weight | molecular- | | |
| | | vinyl polymer (parts) | | | | average | weight vinyl | | |
| | | Phenoxyethyl | Methacrylic | Methyl | Benzyl | molecular | polymer to the | Jetting | |
| Experiment | Synergist | methacrylate | acid | methacrylate | methacrylate | weight | pigment | accuracy | Remarks |
| 301 | S1 | 80 | 20 | 0 | 0 | 13000 | 50% | B | Invention |
| 302 | S1 | 80 | 20 | 0 | 0 | 21000 | 50% | A | Invention |
| 303 | S1 | 80 | 20 | 0 | 0 | 41000 | 50% | A | Invention |
| 304 | S1 | 80 | 20 | 0 | 0 | 60000 | 50% | A | Invention |
| 305 | S1 | 80 | 20 | 0 | 0 | 69000 | 50% | B | Invention |
| 306 | S1 | 80 | 20 | 0 | 0 | 41000 | 20% | B | Invention |
| 307 | S1 | 80 | 20 | 0 | 0 | 41000 | 30% | A | Invention |
| 308 | S1 | 80 | 20 | 0 | 0 | 41000 | 50% | A | Invention |
| 309 | S1 | 80 | 20 | 0 | 0 | 41000 | 60% | A | Invention |
| 310 | S1 | 80 | 20 | 0 | 0 | 41000 | 70% | B | Invention |
| 311 | S1 | 80 | 20 | 0 | 0 | 41000 | 90% | B | Invention |
| 312 | S1 | 80 | 20 | 0 | 0 | 41000 | 110% | B | Invention |

From Experiments 301 to 312, it was found that the weight average molecular weight of the high-molecular-weight vinyl polymer of the invention is preferably from 20,000 to 60,000. It was found that the addition amount of the high-molecular-weight vinyl is preferably from 30% to 60% with respect to the pigment.

### Comparative Example 1

Each of the inkjet recording inks was prepared in the same manner as in Example 1, except that an aqueous dispersion of a colored particle containing a quinacridone pigment, a synergist, and a high-molecular-weight vinyl polymer produced in accordance with Production Example 1 and Example 1 described in JP-A No. 2006-176623 (paragraphs [0050] to [0055]), or an aqueous dispersion of a colored particle containing a quinacridone pigment, a synergist, and a high-molecular-weight vinyl polymer produced in accordance with Example 7 described in JP-A No. 6-345997 (paragraphs [0025] to [0031]), was used as the aqueous dispersion of the colored particle containing the high-molecular-weight vinyl polymer in Example 1 (Experiments 401 and 402). The jetting accuracy was evaluated in the same manner as in Example 1, and the results are shown in Table 4.

TABLE 4

| | | | | Addition | | |
|---|---|---|---|---|---|---|
| | | | | ratio of the | | |
| | | | | high- | | |
| | | | | molecular- | | |
| | | | | weight vinyl | | |
| | | | High-molecular-weight vinyl | polymer to | Jetting | |
| Experiment | Pigment | Synergist | polymer | the pigment | accuracy | Remarks |
| 401 | Dimethyl | Sulfonated dimethyl | Copolymer of benzyl | 50% | D | Comparative |
| | quinacridone | quinacridone | methacrylate, | | | Example |
| | pigment (P.R.122) | | polypropyleneglycol | | | |
| | | | monomethacrylate, | | | |
| | | | polyethyleneglycol | | | |
| | | | monomethacrylate, methacrylic | | | |
| | | | acid, and styrene macromer | | | |
| 402 | Unsubstituted | N-dipropylamino | Copolymer of styrene, ethyl | 50% | D | Comparative |
| | quinacridone | propyl-sulfamoyl | acrylate, methyl methacrylate, | | | Example |
| | pigment (P.V.19) | quinacridone | and methacrylic acid | | | |

From Experiments 401 and 402, it was found that sufficient discharge accuracy could not be obtained when the water-based inks described in JP-A Nos. 2006-176623 and 6-345997 were used.

### Example 4

Each of the inkjet recording inks was prepared in the same manner as in Example 1, except that the monomer composition of the high-molecular-weight vinyl polymer and the weight average molecular weight of the high-molecular-weight vinyl polymer in Example 1 were changed as shown in Table 5 (Experiments 501 to 508). The jetting accuracy was evaluated in the same manner as in Example 1.

TABLE 5

| | | | | | Addition ratio of | | |
|---|---|---|---|---|---|---|---|
| | | | | Weight | the high-molecular- | | |
| | | Compositional ratio | | average | weight vinyl | | |
| | | of high-molecular-weight | | molecular | polymer to the | Jetting | |
| Experiment | Synergist | vinyl polymer (parts) | | weight | pigment | accuracy | Remarks |
| 501 | S1 | Phenoxyethyl | Methacrylic acid: 20 | 41000 | 50% | A | Invention |
| | | methacrylate: 80 | | | | | |
| 502 | S1 | Phenoxyethyl | Methacrylic acid: 20 | 50500 | 50% | B | Invention |
| | | acrylate: 80 | | | | | |
| 503 | S1 | Phenoxyethyl | Acrylic acid: 20 | 44000 | 50% | A | Invention |
| | | methacrylate: 80 | | | | | |
| 504 | S1 | Phenoxyethyl | Acrylic acid: 20 | 49000 | 50% | B | Invention |
| | | acrylate: 80 | | | | | |
| 505 | S1 | Phenoxyethoxyethyl | Methacrylic acid: 20 | 47000 | 50% | C | Comparative |
| | | methacrylate: 80 | | | | | Example |
| 506 | S1 | Methoxy | Methacrylic acid: 20 | 52000 | 50% | D | Comparative |
| | | polyethyleneglycol | | | | | Example |
| | | monomethacrylate: 80 | | | | | |
| 507 | S1 | Paracumylphenol | Methacrylic acid: 20 | 48000 | 50% | D | Comparative |
| | | ethylene oxide- | | | | | Example |
| | | modified acrylate: 80 | | | | | |
| 508 | S1 | Bisphenol A ethylene | Methacrylic acid: 20 | 43000 | 50% | D | Comparative |
| | | oxide-modified | | | | | Example |
| | | diacrylate: 80 | | | | | |

As shown in Table 5, it was found that sufficient jetting accuracy could be obtained when phenoxyethyl methacrylate or phenoxyethyl acrylate is used as the monomer constituting the hydrophobic structural unit in the high-molecular-weight vinyl polymer.

On the other hand, when phenoxyethoxyethyl methacrylate, methoxy polyethyleneglycol monomethacrylate, paracumylphenol ethylene oxide-modified acrylate, or bisphenol A ethylene oxide-modified diacrylate (whose structures are shown below) were used as the monomers constituting the hydrophobic structural unit, sufficient jetting accuracy could not be obtained.

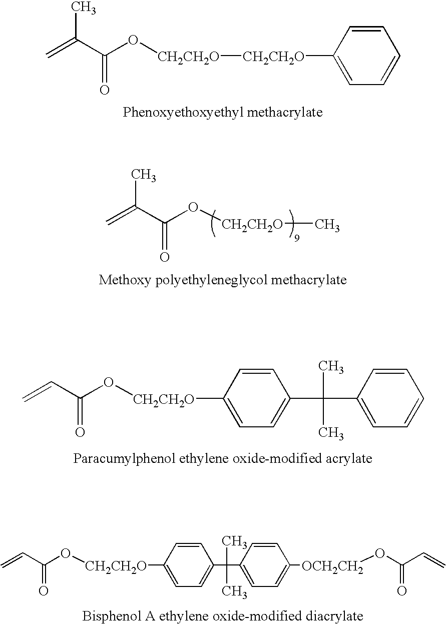

### Example 5

Inkjet recording inks were prepared in the same manner as in Examples 1 to 4, except that Pigment Violet 19 was used as the quinacridone pigment in place of Pigment Red 122 used in Examples 1 to 4. The jetting accuracy was evaluated in the same manner as in Example 1. As a result, the inkjet recording inks of the invention exhibited sufficient performance similar to those of Examples 1 to 4.

### Example 6

The inkjet recording inks prepared in Examples 1 to 5 were placed into high-density polyethylene containers and then sealed and left at room temperature for 3 months, instead of being placed in containers made of PET and then sealed and left at 60° C. for 2 weeks as in Examples 1 to 5. Then, the jetting accuracy was evaluated in the same manner as in Example 1. As a result, it was confirmed that the inkjet recording inks of the invention could exhibit sufficient performance similar to those of Examples 1 to 5.

According to the invention, a water-based inkjet recording ink having excellent jetting stability even after long term storage or after being exposed to high temperatures and can suppress generation of unevenness in density and streaking can be obtained.

All publications, patent applications, and technical standards mentioned in this specification are herein incorporated by reference to the same extent as if such individual publication, patent application, or technical standard was specifically and individually indicated to be incorporated by reference.

What is claimed is:

1. A water-based inkjet recording ink, comprising: a colored particle and an aqueous liquid medium, wherein the colored particle comprises: a quinacridone pigment; a synergist having a basic group; and a high-molecular-weight vinyl polymer having (i) at least one of a hydrophobic structural unit derived from phenoxyethyl acrylate or a hydrophobic structural unit derived from phenoxyethyl methacrylate and (ii) at least one of a hydrophilic structural unit derived from acrylic acid or a hydrophilic structural unit derived from methacrylic acid.

2. The water-based inkjet recording ink of claim 1, wherein the synergist is at least one selected from the group consisting of a quinacridone derivative, a triazine derivative, an acridone derivative, and an anthraquinone derivative.

3. The water-based inkjet recording ink of claim 1, wherein the quinacridone pigment is at least one of C.I. Pigment Red 122 or C. I. Pigment Violet 19, and the synergist is a quinacridone derivative.

4. The water-based inkjet recording ink of claim 2, wherein the quinacridone pigment is at least one of C.I. Pigment Red 122 or C. I. Pigment Violet 19, and the synergist is a quinacridone derivative.

5. The water-based inkjet recording ink of claim 1, wherein the content of the quinacridone pigment is from 2 mass % to 10 mass % with respect to the total mass of the water-based inkjet recording ink.

6. The water-based inkjet recording ink of claim 1, wherein the basic group is at least one selected from the group consisting of a dialkylamino group, a morpholino group, a piperazinyl group, a pyrrolidinyl group, a piperidinyl group, a pyridyl group, and a triazinyl group.

7. The water-based inkjet recording ink of claim 1, wherein the content of the synergist having the basic group is from 0.5 parts by mass to 20 parts by mass based on 100 parts by mass of the pigment.

8. The water-based inkjet recording ink of claim 1, wherein the content of the at least one of a hydrophobic structural unit derived from phenoxyethyl acrylate or a hydrophobic structural unit derived from phenoxyethyl methacrylate is from 20 mass % to 90 mass % and the content of the at least one of a hydrophilic structural unit derived from acrylic acid or a hydrophilic structural unit derived from methacrylic acid is from 5 mass % to 40 mass %, with respect to the total mass of the high-molecular-weight vinyl polymer.

9. The water-based inkjet recording ink of claim 1, wherein the weight average molecular weight of the high-molecular-weight vinyl polymer is from 2,000 to 70,000.

10. The water-based inkjet recording ink of claim 1, wherein the ratio of the addition amount of the high-molecular-weight vinyl polymer is from 10% to 100% with respect to the total mass of the pigment.

11. The water-based inkjet recording ink of claim 1, wherein the content of the colored particle is from 2 mass % to 10 mass % with respect to the total mass of the water-based inkjet recording ink.

12. The water-based inkjet recording ink of claim 1, wherein the aqueous liquid medium comprising a water-soluble organic solvent.

13. The water-based inkjet recording ink of claim 12, wherein the water-soluble organic solvent is a polyol compound.

14. The water-based inkjet recording ink of claim 12, wherein the content of the water-soluble organic solvent is from 5 mass % to 60 mass % with respect to the total amount of the water-based inkjet recording ink.

15. The water-based inkjet recording ink of claim 1, further comprising a surface tension adjusting agent.

16. The water-based inkjet recording ink of claim 1, further comprising resin particles.
